(19) United States
(12) Patent Application Publication
(10) Pub. No.: US 2007/0128931 A1
(43) Pub. Date: Jun. 7, 2007

(54) Polyester gel adapted for use with polycarbonate components

(76) Inventors: Ziwei Liu, Fort Worth, TX (US); Paul J. Huspeni, Keller, TX (US)

Correspondence Address: CORNING CABLE SYSTEMS LLC, P O BOX 489, HICKORY, NC, 28603, US

(21) Appl. No.: 11/606,151

(22) Filed: Nov. 29, 2006

Related U.S. Application Data
(60) Provisional application No. 60/742,251, filed on Dec. 5, 2005.

(51) Int. Cl. H01R 13/40

(52) U.S. Cl. 439/587

(57) ABSTRACT

There is provided a polyester gel including a part A including a maleinized polybutadiene family member in an amount of at least 50 parts of part A, a plasticizer in the amount of at least 30 parts of part A, and a stabilizer in an amount of at least 1 part of part A. The polyester gel also includes a part B including a liquid hydroxyl terminated polymer of butadiene in an amount of at least 60 parts of part B, a plasticizer in an amount of at least 30 parts of part B, and a catalyst in at least 0.0007 parts of part B, wherein parts A and B are about in a one to one ratio. The polyester gel is adapted for use with polycarbonate components, including housings for electronic components, such that the gel does not chemically attack or otherwise compromise the material properties of the polycarbonate component.

### CROSS REFERENCE TO RELATED APPLICATION

The present application claims priority pursuant to 35 U.S.C. 119(e) to U.S. Provisional Application, Ser. No. 60/742,251, filed Dec. 5, 2005.

### BACKGROUND OF THE INVENTION

1. Field of the Invention

The present invention relates generally to telecommunication line equipment. More particularly, the invention relates to multiple cross connect hardware gels and methods for fabricating such gels.

2. Technical Background

Non-silicone sealants are useful for environmental protection in outdoor located equipment as well as outdoor located telecommunication equipment. Silicone sealants often wick or flow to neighboring telecommunication equipment, which can adversely affect certain components of equipment. Therefore, a need exists to replace silicone sealants with non-silicone sealants.

Furthermore, it is often desired to use polycarbonate as a material for many portions of such telecommunication equipment, for at least the reason of the relatively cost-effective price of polycarbonate. However, it is well known that many sealants may chemically attack polycarbonate over time, thus causing failure of such equipment in certain situations. Therefore, a need exists for a non-silicone sealant that does not significantly chemically attack polycarbonate components.

### BRIEF SUMMARY OF THE INVENTION

The various embodiments of the present invention address the above needs and achieve other advantages by providing a polyester gel that is adapted for use with polycarbonate components, including housings for electronic components, such that the gel does not chemically attack or otherwise compromise the material properties of the polycarbonate component. The polyester gel, once cured, is able to retain and seal electrical components without undesirable wicking and without undesirable chemical corrosion of associated polycarbonate components.

In one aspect, the present invention is directed to a composition including a part A including a maleinized polybutadiene family member in an amount of at least 50 parts of part A, a plasticizer in an amount of at least 30 parts of part A, and a stabilizer in an amount of at least 1 part of part A. The composition also includes a part B including a liquid hydroxyl terminated polymer of butadiene in an amount of at least 60 parts of part B, a plasticizer in an amount of at least 30 parts of part B, and a catalyst in at least 0.0007 parts of part B, wherein parts A and B are about in a one to one ratio.

In one embodiment, the stabilizer includes tetrakis-(methylene-(3,5-diterbutyl-4-hydrocinnamate) methane.

In one embodiment, the maleinized polybutadiene family member has a molecular weight of less than 2800 and an anhydride equivalent weight of more than 1000.

In one embodiment, the maleinized polybutadiene family member has a molecular weight of about 2700 and an anhydride equivalent weight of about 1238.

In one embodiment, the maleinized polybutadiene family member has a viscosity at 25° C. of about 6500 cps and a number of functional groups per chain ratio of two.

In one embodiment, the liquid hydroxyl terminated polymer of butadiene comprises a Poly bd R-45HTLO resin.

In one aspect, the present invention is directed to a composition comprising a gel, wherein the gel has a tensile strength of about 0.04 MegaPascals (MPa), an elongation to break of about 290 percent, a toughness of about 0.09 MPa, and a shore 000 hardness of about 81.

In one embodiment, the gel has a dielectric constant at 25° C. of about 2.7 and an ionic conductivity of less than 1 (ohms-cm)⁻¹.

In one embodiment, the gel has a tensile strength of 0.046 MPa, an elongation to break of 292.4 percent, and a toughness of 0.094 MPa.

Additional features and advantages of the invention are set out in the detailed description which follows, and in part will be readily apparent to those skilled in the art from that description or recognized by practicing the invention as described herein, including the detailed description which follows, as well as the appended drawings.

It is to be understood that both the foregoing general description and the following detailed description present exemplary embodiments of the invention, and are intended to provide an overview or framework for understanding the nature and character of the invention as it is claimed, and not for reasons of limitation. The accompanying drawings are included to provide a further understanding of the invention and are incorporated into and constitute a part of this specification. The drawings illustrate various embodiments of the invention, and together with the detailed description, serve to explain the principles and operations thereof, and are not provided for reasons of limitation.

### BRIEF DESCRIPTION OF THE SEVERAL VIEWS OF THE DRAWINGS

FIG. 1 is a side view of a connector in accordance with one embodiment of the present invention.

FIG. 2 is a cross-sectional view of the connector of FIG. 1, wherein a maximum gel level is illustrated.

FIG. 3 is an enlarged view of connector ports and insulation displacement members of the connector of FIG. 1.

FIG. 4 is a further enlarged view of a connector port and insulation displacement member of the connector of FIG. 1, wherein a minimum gel level is illustrated.

### DETAILED DESCRIPTION OF THE INVENTION

Reference will now be made in detail to several exemplary embodiments of the invention, and examples of which are illustrated in the accompanying drawings. Whenever possible, the same reference numerals will be used throughout the drawings to refer to the same or like parts.

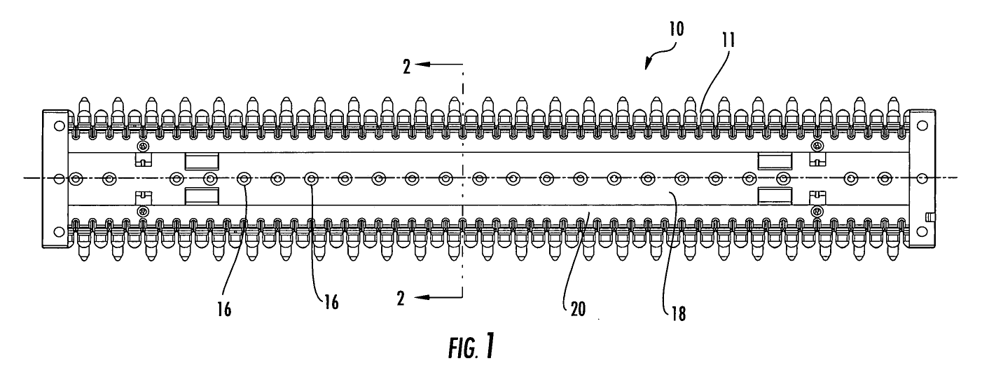

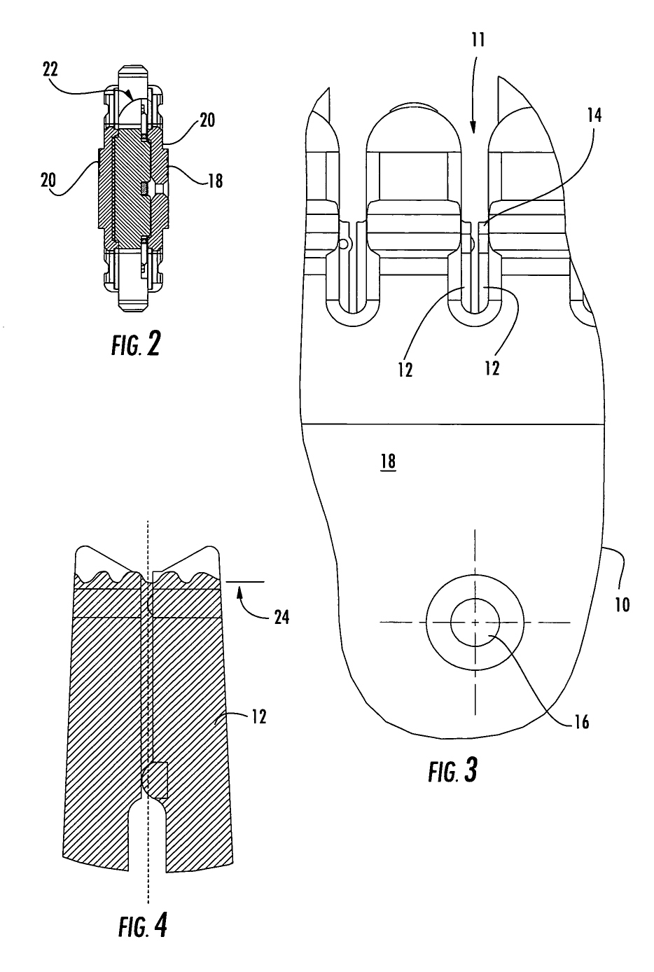

FIG. 1 illustrates a connector 10 such as an interface connector (such as a UMOXS1A connector available from Corning Cable Systems LLC of Hickory, N.C. (hereinafter “CCS”), or a bridging connector such as a UMOXS2A connector also available from CCS, or a multiplexing connector such as a UMOXS5A connector also available from CCS, wherein connector 10 has a gel as described in detail below in each connector port 11. As seen in FIG. 3, port 11 includes two insulation displacement members 12 which each end at a top portion 14. Preferably the gel completely covers and protects top portions 14. However, it is contemplated that the benefits of the invention accrue to embodiments without top portions 14 being covered with a gel.

The connector 10 of FIGS. 1-4 enables copper wires (not shown) that are positioned in the ports 11 at opposite sides of the connector to be electrically connected to one another. As known in the art, the insulation displacement members 12 are sized to receive copper wires of a predetermined size and to displace at least a portion of the insulation when the copper wire is inserted into the slot of the port. A sealing gel is commonly inserted into connectors 10, such as the UMOXS1A to provide one non-limiting example, through one or more openings 16 of the connector housing 18 once the connector has been substantially assembled. A predetermined amount of gel is inserted into the housing of the connector such that a portion of the gel passes between the housing portions 20, as seen in FIG. 2, and the insulation displacement members 12 to substantially seal the exterior portion of the insulation displacement member (the portion of the insulation displacement member not enclosed within the housing). In some embodiments of the present invention, the gel is inserted by injecting the gel through needles into one or more openings. Preferably, a sufficient amount of gel is provided such that the top portions 14 of the insulation displacement members 12 are substantially covered, such as is shown by the maximum gel level 22 in FIG. 2. However, as indicated by the minimum gel level 24 of FIG. 4, the minimum gel level may suffice in order that the portion of the insulation displacement member 12 that contacts the copper wire is substantially covered by the gel. Once the gel has been inserted to the desired level, the gel is cured by conventional curing procedures.

In one aspect, the present invention is directed to a composition including a part A including a maleinized polybutadiene family member in an amount of at least 50 parts of part A, a plasticizer in an amount of at least 30 parts of part A, and a stabilizer in an amount of at least 1 part of part A. The composition also includes a part B including a liquid hydroxyl terminated polymer of butadiene in an amount of at least 60 parts of part B, a plasticizer in an amount of at least 30 parts of part B, and a catalyst in at least 0.0007 parts of part B, wherein parts A and B are about in a one to one ratio with respect to weight. The resultant composition (a gel) of parts A and B combined has a tensile strength of about 0.046 (MPa), an elongation to break (%) of about 292.4, a toughness (MPa) of about 0.094, a hardness (shore 000) of about 81, and a dielectric constant at 25° C. of 2.7 (ohms-cm)⁻¹. The gel is polyester gel which does not chemically attack the polycarbonate components of connector 10. Therefore, it has been empirically determined that connector 10 with the herein described gel as a sealing compound can withstand multiple temperature cycling and humidity exposure without failing or cracking. The gel is compatible with electronic circuitry and inside wire insulation also. An example of a liquid hydroxyl terminated polymer of butadiene is Poly bd R-45HTLO available from the Sartomer Company. The liquid hydroxyl terminated polymer of butadiene in part B can be from 60 to 70 parts. The plasticizer can be from 30 to 40 parts of part B, and the catalyst can be from 0.007 to 0.008 parts. A suitable catalyst is “Polycat 41” available from Air Products.

In one embodiment, the stabilizer includes tetrakis-(methylene-(3,5-diterbutyl-4-hydrocinnamate) methane. An example of a stabilizer is Irganox 1010 available from the Ciba Specialty Chemicals Corporation. The plasticizer can be from 50 parts to 30 parts of part A.

In one embodiment, the maleinized polybutadiene family member has a molecular weight of less than 2800 and an anhydride equivalent weight of more than 1000. An example of maleinized polybutadiene family member is Ricon 130 MA8 available from the Sartomer Company of Eston Pa. Ricon 130 MA8 has a Molecular weight (Mn) of about 2700 g/mole, a viscosity @25° of 6500 cps (centipoise), a number of functional groups per chain of 2, and an anhydride equivalent weight of about 1238. Therefore, in one embodiment, the maleinized polybutadiene family member has a molecular weight of about 2700 and an anhydride equivalent weight of about 1238. The Ricon 130 MA8 can be between 50 and 70 parts of part A. Typically, the plasticizers of parts A and B are the same plasticizer and are an inert component.

In one embodiment, the maleinized polybutadiene family member has a viscosity at 25° C. of about 6500 cps and a number of functional groups per chain ratio of two.

In one embodiment, the liquid hydroxyl terminated polymer of butadiene comprises a Poly bd R-45HTLO resin.

In one aspect, the present invention is directed to a composition comprising a gel, wherein the gel has a tensile strength of about 0.04 MegaPascals (MPa), an elongation to break of about 290 percent, a toughness of about 0.09 MPa, and a shore 000 hardness of about 81.

In one embodiment, the gel has a dielectric constant at 25° C. of about 2.7 and an ionic conductivity of less than 1 (ohms-cm)⁻¹.

In one embodiment, the gel has a tensile strength of 0.046 MPa, an elongation to break of 292.4 percent, and a toughness of 0.094 MPa.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

That which is claimed:

1. A connector assembly for connecting one or more copper wires, the connector assembly comprising:
at least one insulation displacement member adapted to provide electrical contact with the one or more copper wires;
a housing defining an interior cavity with an interior surface, wherein the at least one insulation displacement member is at least partially disposed within the interior cavity; and
a polyester gel within at least a portion of the interior cavity such that the polyester gel contacts at least a portion of the interior surface;
wherein the at least a portion of the interior surface of the housing defines a polycarbonate material;
wherein the polyester gel comprises a part A including a maleinized polybutadiene family member in an amount of about 50 parts or more of part A, a plasticizer in an amount of about 30 parts or more of part A, and a stabilizer in an amount of about 1 part or more of part A and comprises a part B including a liquid hydroxyl terminated polymer of butadiene in an amount of about 60 parts or more of part B, a plasticizer in an amount of about 30 parts or more of part B, and a catalyst in an amount of about 0.0007 parts or more of part B, wherein the polyester gel generally defines a one to one ratio by weight of part A and part B.

2. A connector assembly according to claim 1, wherein the housing defines at least one opening through which the polyester gel is inserted.

3. A connector assembly according to claim 1, wherein the insulation displacement member defines a top portion that is covered by the polyester gel.

4. A connector assembly according to claim 1, wherein the polyester gel defines a tensile strength of about 0.04 MegaPascals, an elongation to break of about 290 percent, a toughness of about 0.09 MPa, and a shore 000 hardness of about 81.

5. A connector assembly according to claim 1, wherein the polyester gel defines a tensile strength of about 0.046 MegaPascals, an elongation to break of about 292.4 percent, and a toughness of about 0.094 MPa.

6. A connector assembly according to claim 1, wherein the polyester gel defines a dielectric constant at 25° C. of about 2.7 and an ionic conductivity of less than one (ohms-cm)⁻¹.

7. A connector assembly according to claim 1, wherein the stabilizer of part A comprises tetrakis-(methylene-(3,5-diterbutyl-4-hydrocinnamate) methane.

8. A connector assembly according to claim 1, wherein the maleinized polybutadiene family member of part A defines a molecular weight of less than 2800 and an anhydride equivalent weight of more than 1000.

9. A connector assembly according to claim 1, wherein the liquid hydroxyl terminated polymer of butadiene of part B comprises a Poly bd R-45HTLO resin.

10. A polyester gel adapted for use with polycarbonate components, the polyester gel comprising:
a part A including a maleinized polybutadiene family member in an amount of about 50 parts or more of part A, a plasticizer in an amount of about 30 parts or more of part A, and a stabilizer in an amount of about 1 part or more of part A; and
a part B including a liquid hydroxyl terminated polymer of butadiene in an amount of about 60 parts or more of part B, a plasticizer in an amount of about 30 parts or more of part B, and a catalyst in an amount of about 0.0007 parts or more of part B;
wherein the polyester gel generally defines a one to one ratio by weight of part A and part B.

11. A polyester gel according to claim 10, wherein the polyester gel defines a tensile strength of about 0.04 MegaPascals, an elongation to break of about 290 percent, a toughness of about 0.09 MPa, and a shore 000 hardness of about 81.

12. A polyester gel according to claim 10, wherein the stabilizer of part A comprises tetrakis-(methylene-(3,5-diterbutyl-4-hydrocinnamate) methane.

13. A polyester gel according to claim 10, wherein the maleinized polybutadiene family member of part A defines a molecular weight of less than 2800 and an anhydride equivalent weight of more than 1000.

14. A polyester gel according to claim 10, wherein the maleinized polybutadiene family member of part A defines a viscosity at 25° C. of about 6500 cps and a number of functional groups per chain ratio of two.

15. A polyester gel according to claim 10, wherein the liquid hydroxyl terminated polymer of butadiene of part B comprises a Poly bd R-45HTLO resin.

16. A method of manufacturing a connector assembly for connecting one or more copper wires, the method comprising:
securing at least one insulation displacement member at least partially within a connector housing, wherein the insulation displacement member is adapted to provide electrical contact with the one or more copper wires, and wherein the connector housing defines an interior cavity with an interior surface, wherein at least a portion of the interior surface of the housing defines a polycarbonate material; and
inserting a polyester gel within at least a portion of the interior cavity such that the polyester gel contacts at least a portion of the interior surface;
wherein the polyester gel comprises a part A including a maleinized polybutadiene family member in an amount of about 50 parts or more of part A, a plasticizer in an amount of about 30 parts or more of part A, and a stabilizer in an amount of about 1 part or more of part A and comprises a part B including a liquid hydroxyl terminated polymer of butadiene in an amount of about 60 parts or more of part B, a plasticizer in an amount of about 30 parts or more of part B, and a catalyst in an amount of about 0.0007 parts or more of part B, wherein the polyester gel generally defines a one to one ratio by weight of part A and part B.

17. A method according to claim 16, further comprising curing the polyester gel after the polyester gel has been inserted into the interior cavity of the housing portion.

18. A method according to claim 16, wherein the polyester gel defines a tensile strength of about 0.04 MegaPascals, an elongation to break of about 290 percent, a toughness of about 0.09 MPa, and a shore 000 hardness of about 81.

19. A method according to claim 16, wherein inserting the polyester gel comprises injecting the polyester gel through one or more openings of the connector housing.

20. A method according to claim 16, wherein inserting the polyester gel comprises passing a portion of the gel between a housing portion and the at least one insulation displacement member to substantially seal an exterior portion of the at least one insulation displacement member.
